(19) United States
(12) Patent Application Publication
(10) Pub. No.: US 2003/0108337 A1
(43) Pub. Date: Jun. 12, 2003

(54) Electronic instrument

(75) Inventors: Masaaki Tsuchida, Tokyo (JP); Yoshito Katagiri, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Corporation, Tokyo (JP)

(21) Appl. No.: 10/310,531

(22) Filed: Dec. 5, 2002

(30) Foreign Application Priority Data
Dec. 7, 2001 (JP) 2001-374217

(51) Int. Cl. H04N 5/76; H04N 5/225

(52) U.S. Cl. 386/95; 386/117; 348/231.3

(57) ABSTRACT

An eletronic instrument includes: an analyzer that analyzes an image stored in an image storage device; a judging device that judges whether tag information corresponding to the image that is stored is appropriate or not, based on the results of analyses by the analyzer; a correction information forming device that forms correction information showing that the tag information has been corrected based on the results of analyses, when the tag information related with the image was judged not to be appropriate; and a tag information setting device that establishes the tag information by including the correction information.

### BACKGROUND OF THE INVENTION

The present invention relates to an electronic instrument, and in particular, to a digital camera.

There has been proposed a technology to add various pieces of information relating to photographing conditions such as the date and time of photographing, a title, an aperture value and exposure correction, to an image taken through photographing, as tag information, and by referring to the tag information, it is possible to conduct retrieval and administration of an image file, and to conduct appropriate image processing on the output apparatus side to output efficiently.

However, the tag information includes various pieces of information, and detailed setting conditions need to be established. Therefore, if a user does not have knowledge about photographing to a certain extent, it is difficult to set optimum information on various types of tag information, and there has been a problem that a user established erroneously and a desired image with high image quality was not outputted.

### SUMMARY OF THE INVENTION

An object of the invention is to provide a highly convenient electronic instrument wherein tag information that is most appropriate to an image can be set.

The object stated above can be attained by either one of the following Structures (1)-(13).

Structure (1): An electronic instrument including: an analyzing means that analyzes an image stored in an image storage means; a judging means that judges whether tag information corresponding to the image is appropriate or not, based on the results of analyses of the tag information being stored in the storage means; a correction information forming means that forms correction information showing that the tag information has been corrected based on the results of analyses, when the tag information related with the image was judged not to be appropriate; and a tag information setting means that establishes the tag information by including the correction information.

Structure (2): The electronic instrument according to the Structure (1) including further: an imaging means that picks up the image; an image storage means that stores the image picked up by the imaging means wherein the tag information setting means establishes tag information corresponding to the image picked up by the imaging means; and a storage control means that makes the image storage means to store the tag information related with the image picked up by the imaging means.

Structure (3): The electronic instrument according to the Structure (2), wherein the tag information setting means sets the first tag information relating to photographing conditions and the second tag information, the judgment means judges whether the tag information relating to the photographing conditions is appropriate or not, and there is provided a correction means for correcting the tag information relating to the photographing modes, the correction means corrects the second tag information when the established first tag information is judged not to be appropriate by the judgment means, and the correction information preparing means forms correction information showing that the second tag information was corrected, when the established first tag information is judged not to be appropriate by the judgment means.

Structure (4): The electronic instrument according to the Structure (2), wherein, there is provided an image processing means which conducts image processing for the image when the established tag information relating to the photographing conditions is judged not to be appropriated by the judgment means.

Structure (5): An electronic instrument including: an instructing means that instructs to change the establishment of tag information related with an image stored in an image storage means; a judging means that judges whether the instruction by the instructing means for changing the establishment of tag information is appropriate or not; and a tag information setting means that changes tag information to the establishment instructed by the instructing means, when the instruction for changing the establishment of the tag information is judged to be appropriate by the judging means.

Structure (6): The electronic instrument according to the Structure (5) including further: an imaging means that picks up images; an image storage means that stores the picked up images; a tag information setting means that sets the tag information related with the images picked up; and a storage control means that makes the image storage means to store the established tag information related with the image picked up.

Structure (7): The electronic instrument according to the Structure (6), wherein there are provided an analyzing means that analyzes the images picked up, and a correction information forming means that forms correction information showing that the tag information was corrected based on the results of the analyses, and the tag information setting means sets tag information by adding the correction information to the established tag information, while, the judgment means judges whether the instructions for changing the settings of tag information carried out by the instruction means are appropriate or not by judging whether the tag information instructed by the instruction means includes the correction information or not.

Structure (8): The electronic instrument according to the Structure (6), wherein there is provided a warning means which warns that the tag information is optimized and changes of settings are not appropriate accordingly, when the instructions for changing the settings of tag information are judged not to be appropriate by the judgment means.

Structure (9): The electronic instrument according to the Structure (6), wherein, when the instructions for changing the settings of tag information are judged not to be appropriate by the judgment means, the tag information setting means prohibits the change of tag information that conforms to the instructions for changing the settings of tag information given by the instruction means.

Structure (10): The electronic instrument according to the Structure (6), wherein the judgment means judges whether the tag information instructed by the instruction means is appropriate or not, based on the results of the analyses made by the analysis means.

Structure (11): The electronic instrument according to the Structure (6), wherein the tag information setting means changes tag information instructed by the instruction means, independently of the results of the judgment by the judgment means.

Structure (12): The electronic instrument according to the Structure (6), wherein the tag information setting means sets the first tag information relating to photographing conditions and the second tag information relating to photographing modes, and the instruction means gives instructions for changing the settings of the second tag information.

Structure (13): An electronic instrument including: an imaging means that picks up an image; an image storage means that stores the image picked up; a tag information setting means that sets the tag information relating with the image picked up; a storage control means that makes the image storage means to store the established tag information related with the image picked up; an analyzing means that analyzes the image picked up; a judging means that judges whether tag information established by the tag information setting means is appropriate or not, based on the results of the analyses by the analyzing means; and a correction information forming means that forms correction information showing that the tag information has been corrected based on the results of analyses, when the tag information established was judged not to be appropriate by the judging means, wherein the tag information setting means establishes tag information by including the formed correction information in the tag information.

Further, another preferable Structures (14)-(23) are as follows.

Structure (14): An electronic instrument having therein an imaging means to pick up images, an image storing means to store the images picked up, a tag information setting means to set tag information corresponding to the images picked up and a storage control means to store the established tag information in the image storing means by making the tag information to correspond to the images picked up, wherein there are provided an analysis means that analyzes the images picked up, a judgment means that judges whether the tag information set by the tag information setting means is appropriate or not based on the results of the analyses, and a correction information preparing means that forms correction information showing that the tag information was corrected based on the results of the analyses, when the tag information set by the judgment means was judged not to be appropriate, and the tag information setting means sets the tag information by including the aforesaid formed correction information in the tag information.

This structure makes it possible to provide a highly convenient electronic instrument wherein tag information that is optimum for an image can be established. Further, tag information is judged whether it is appropriate or not based on the results of analyses of the image, and when it is judged not to be appropriate, correction information showing that tag information was corrected is formed to be included in the tag information. It is therefore possible to add tag information that is optimum for output of the image to the image, and thereby to improve convenience.

Therefore, a user can output an image which has high image quality and gives feeling of high satisfaction, by referring to this tag information in the course of outputting.

Structure (15): The electronic instrument according to Structure (14), wherein the tag information setting means sets the first tag information relating to photographing conditions and the second tag information relating to the photographing modes, the judgment means judges whether the tag information relating to the photographing conditions is appropriate or not, and there is provided a correction means for correcting the tag information relating to the photographing modes, when the established tag information relating to the photographing conditions is judged not to be appropriate by the judgment means, and the correction information preparing means forms correction information showing that the tag information relating to the photographing modes was corrected, when the established tag information relating to the photographing conditions is judged not to be appropriate by the judgment means.

Owing to this structure, tag information is judged whether it is appropriate or not based on the results of analyses of the image, when it is judged not to be appropriate, correction information showing that tag information was corrected, and is included in the tag information. Therefore, tag information that is optimum for output of the image can be added to the image, and convenience can be improved.

Therefore, a user can output an image which has high image quality and gives feeling of high satisfaction, by referring to this tag information in the course of outputting.

Structure (16): The electronic instrument according to Structure (14) or Structure (15), wherein there is provided an image processing means which conducts image processing for the image when the established tag information relating to the photographing conditions is judged not to be appropriated by the judgment means.

In the Structure (16), tag information is judged whether it is appropriate or not, based on the results of the analyses of the image, and when it is judged not to be appropriate, correction information showing that the tag information was corrected is formed and is included in the tag information. Therefore, it is possible to add to the image the tag information appropriate for outputting an image, and to improves convenience.

Further, when tag information concerning radiographing conditions is judged not to be appropriate, images are subjected to image processing. Therefore, it is possible to obtain easily an image that matches the tag information more and has high image quality.

Structure (17): An electronic instrument having therein an imaging means to pick up images, an image storing means to store the images picked up, a tag information setting means to set tag information corresponding to the images picked up and a storage control means to store the established tag information in the image storing means by making the tag information to correspond to the images picked up, wherein there are provided an instruction means that gives instructions for changing the settings of tag information carried out by the tag information setting means and a judgment means that judges whether the instructions for changing the settings of tag information carried out by the instruction means are appropriate or not, and when the instructions for changing the settings of tag information are judged to be appropriate by the judgment means, the tag information setting means changes the tag information to the settings instructed by the instruction means.

Structure (18): The electronic instrument according to Structure (17), wherein there are provided an analysis means that analyzes the images picked up, and a correction information forming means that forms correction information showing that the tag information was corrected based on the results of the analyses, and the tag information setting means sets tag information by adding the formed correction information to the established tag information, while, the judgment means judges whether the instructions for changing the settings of tag information carried out by the instruction means are appropriate or not by judging whether the tag information instructed by the instruction means includes the correction information or not.

Structure (19): The electronic instrument according to Structure (17) or Structure (18), wherein there is provided a warning means which warns that the tag information is optimized and changes of settings are not appropriate accordingly, when the instructions for changing the settings of tag information are judged not to be appropriate by the judgment means.

Structure (20): The electronic instrument according to either one of Structures (17)-(19), wherein, when the instructions for changing the settings of tag information are judged not to be appropriate by the judgment means, the tag information setting means prohibits the change of tag information that conforms to the instructions for changing the settings of tag information given by the instruction means.

Structure (21): The electronic instrument according to either one of Structures (17)-(20), wherein the judgment means judges whether the tag information instructed by the instruction means is appropriate or not, based on the results of the analyses made by the analysis means.

Structure (22): The electronic instrument according to Structures (17), wherein the tag information setting means changes tag information instructed by the instruction means, independently of the results of the judgment by the judgment means.

Structure (23): The electronic instrument according to either one of Structures (17)-(22), wherein the tag information setting means sets the first tag information relating to photographing conditions and the second tag information relating to photographing modes, and the instruction means gives instructions for changing the settings of the tag information relating to photographing modes.

In the invention described in Structures (17) to (23), when there are given instructions for changing the settings of tag information, the instructions for changing the settings are judged whether they are appropriate or not, and when the instructions for changing the settings are judged to be appropriate, the tag information is changed to the instructed setting, which makes it possible for a user to set properly the desired tag information. Therefore, a user can output an image which has high image quality and gives a feeling of high satisfaction, by referring the tag information in the course of outputting.

Further, in the Structure (18), correction information showing that tag information was corrected is formed based on the results of analyses of the image obtained through radiographing, and then, tag information is established by adding the formed correction information to the established tag information, and the instructions for changing the establishment of the tag information is judged whether it is appropriate or not by judging the tag information instructed by the instruction means whether it includes the correction information or not. Therefore, the tag information desired by a user can be established to be more suitable for the image.

Further, in the inventions described in the Structures (17) and (18), wrong establishment can be prevented.

In the invention described in Structures (21), whether the tag information instructed to change the settings is appropriate or not is judged based on the results of analyses, thus, it is possible to set tag information that is optimum for outputting images.

In the Structure (22), tag information is changed in accordance with the instruction for changing the setting, independently of the result of the judgment. Therefore, setting desired by a user, for example, setting reflecting the user's taste can be conducted.

The Structure (23) makes it possible to obtain an image which is desired more by a user, in the case of output.

### BRIEF DESCRIPTION OF THE DRAWINGS

FIG. 1 is a block diagram showing the structure of digital camera 1 of the embodiment to which the invention is applied.

FIG. 2 is a flow chart illustrating tag information setting processing executed by CPU 2 in FIG. 1.

FIG. 3(a) is a diagram showing an example of tag information relating to photographing conditions formed by CPU 2 in FIG. 1, and FIG. 3(b) is a conceptual diagram showing an example of adding tag information to an image.

FIG. 4 is a flow chart illustrating tag information change processing that is conducted by CPU 2 in FIG. 1.

### DETAILED DESCRIPTION OF THE PREFERRED EMBODIMENT

An embodiment of the invention will be explained in detail as follows, referring to the drawings.

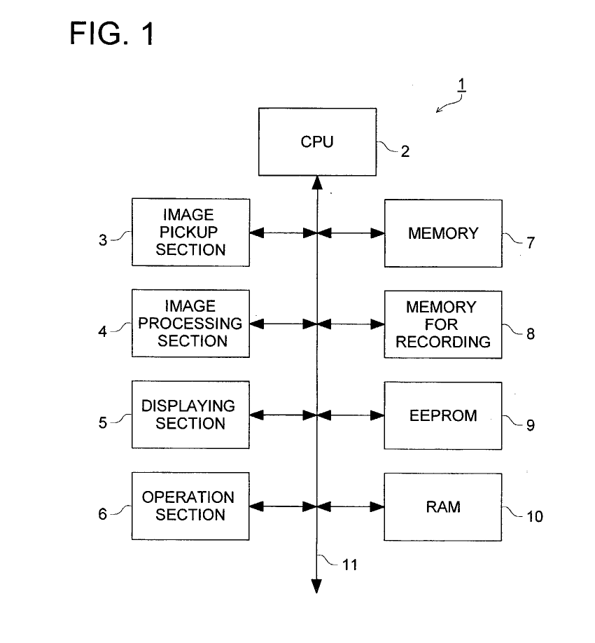

Each of FIGS. 1-5 is a diagram showing an embodiment of digital camera 1 to which the invention is applied.

First, the structure will be explained.

FIG. 1 is a block diagram showing the functional structure of digital camera 1 in the present embodiment. As shown in FIG. 1, the digital camera 1 is composed of CPU 2, image pick-up section 3, image processing section 4, display section 5, operation section 6, memory 7, memory for recording 8, EEPROM 9 and RAM 10, and respective constituting sections are connected by bus 11.

CPU (Central Processing Unit) 2 develops, on an unillustrated work area in RAM 10, the program designated from various application programs relating to image pick-up which are housed in EEPROM 9, and conducts various processing such as photographing processing, tag information setting processing and tag information change processing, following the designated program, in accordance with data inputted from each constituting section such as operation section 6, to display the results of the processing on display section 5.

Further, CPU 2 judges, after analyzing images in tag information setting processing described later, whether the photographing was carried out under the manual mode (mode in which a photographer establishes various photographing parameters necessary for exposure, and photographing processing is conducted based on the established photographing parameters) or not, and when the photographing was carried out under the manual mode, CPU 2 forms tag information where photographing conditions are set, while when the photographing was not carried out under the manual mode but was carried out under the automatic mode (mode in which photographing conditions such as exposure conditions are set automatically by a camera, and photographing processing is conducted based on the set photographing conditions, exemplified, for example, by an automatic exposure mode in which an optimum exposure condition is calculated by a camera from a photometric value, and an automatic white balance mode in which an optimum white balance condition is calculated by a camera from a photometric value), for example, CPU 2 analyzes images, then, judges whether correction is needed for the photographing conditions, based on the results of the analyses, and when the correction is needed, CPU 2 calculates an amount of correction for images based on the results of the analyses, then, conducts correction on the images based on the amount of correction, and corrects the photographing mode relating to the photographing conditions requiring the correction, and CPU 2 forms tag information on which the correction information showing that correction was made on the tag information for photographing conditions and photographing modes is recorded, to add to the corresponding images.

Furthermore, CPU 2 makes display section 5 to display an image screen for inputting changes of settings for tag information first, in tag information change processing (processing for changing the contents of tag information which has already been added to the image in tag information setting processing), then, judges whether the tag information has correction information relating to the inputted item to be changed or not, and when the tag information has the correction information, CPU 2 makes display section 5 to display a warning message which warns that the tag information has already been optimized, and prohibits changes of settings. On the other hand, when the tag information has no correction information, CPU 2 analyzes images, then, judges whether settings (conditions) to be changed are appropriate or not, based on the results of the analyses, and when they are appropriate, CPU 2 changes the settings of the tag information and adds to the corresponding images, while when they are not appropriate, CPU 2 displays a warning message which warns that optimum correction may not be made in the course of outputting, and makes display section 5 to display a message inquiring whether to change the setting independently of the warning or not, and when there is an instruction to change the setting, the settings of the tag information are changed and added to the corresponding images, while when there is no instruction to change the setting, CPU 2 terminates the tag information change processing without changing the settings.

Namely, CPU 2 is provided with functions as a tag information setting means, a storage control means, an analysis means, a judgment means, a correction information forming means and a correction means.

Image pick-up section 3 is composed of a lens unit that is made up of a focus lens group which takes in optical images of a subject, a diaphragm (shutter which also serves as a diaphragm) that adjusts an amount of light of a light flux transmitted through the lens unit and adjusts the exposure time, and of CCD that converts an optical image of a subject formed on an optical path of the lens unit, and it takes in optical images of the subject and convert them in image signals photoelectrically. Namely, the image pick-up section 3 is provided with a function as an image pick-up means.

Image processing section 4 generates prescribed image signals by conducting image corrections in various types such as sensitivity correction on the image signals obtained through photoelectric conversion, and converts the image signals (analog signals) into digital signals in accordance with the instructions from CPU 2. When displaying images on display section 5, digital signals are converted into analog signals. Further, the image processing section 4 conducts compression processing for compressing image data converted into digital signals with a prescribed encoding system, and expanding processing for decoding the compressed image data and expanding them. Further, the mage processing section 4 conducts correction processing (image processing) on image data in accordance with the instructions from CPU 2.

Display section 5 is composed of LCD (Liquid Crystal Display) and others, and it outputs and displays image signals obtained through image processing in accordance with display instructions from CPU 2. The display section 5 further outputs and displays results of various processing and situations of photographing by CPU 2, a screen of menu for selecting functions and a screen of a change of setting.

Operation section 6 is constituted to be provided with a release button for releasing the shutter and with various types of operating buttons to instruct the switching for selection of various types of setting and for functions. When each operating button is operated (pressed in the present embodiment), its operation signal (depression signal) is generated and outputted to CPU 2. Namely, the operation section 6 has a function as an instructing means.

Memory 7 is composed of a buffer memory and others, and it stores temporarily image data which have been processed by the image processing section 4. Further, when it receives an instruction for image recording from CPU 2, it outputs the image data which have been stored in it to memory for recording 8.

The memory for recording 8 is a memory for recording composed of a semiconductor memory and others, and it is a recording medium on which the image data inputted from the memory 7 are recorded. The memory for recording 8 may be, for example, either a memory of a built-in type such as a flush memory or the like, or a detachable memory card or memory stick, and it may further be a magnetic recording medium such as a hard disk or a floppy (registered trademark) disk. Namely, the memory for recording 8 is provided with a function as an image storage means.

EEPROM (Electrically Erasable Programmable Read-Only Memory) 9 stores various types of application programs relating to image pick-up in digital camera 1 and processing programs.

RAM (Random Access Memory) 10 forms a work area which serves as a temporally housing area for programs, input or output data which are read out of EEPROM 9 and parameters.

Next, operations of the present embodiment will be explained.

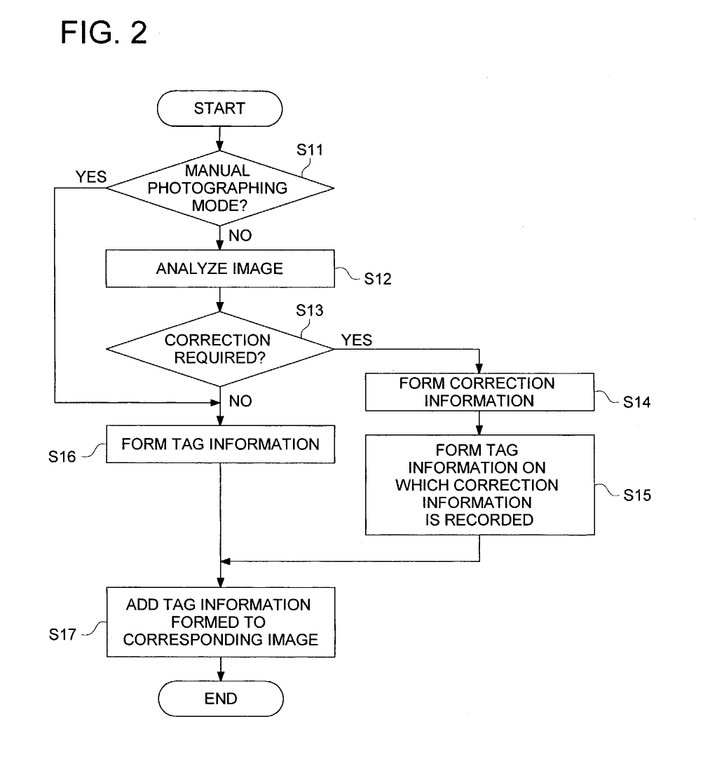

Referring to FIG. 2, there will be explained a tag information setting processing which sets tag information that is optimum for images photographed after photographing.

FIG. 2 is a flow chart illustrating information setting processing executed by CPU 2 of digital camera 1.

In FIG. 2, CPU 2 first judges whether or not the photographing was conducted under the manual mode to photograph under the photographing conditions set by a user (step S 11). When the photographing was conducted under the manual mode (step S 11; YES), there is formed tag information including tag information relating to photographing conditions set by a user in the course of photographing and tag information relating to the photographing mode showing that the photographing mode was a manual mode (step S 16), then, the tag information thus formed is added to the corresponding image (step S 17) to terminate the tag information setting processing.

When tag information includes both tag information relating to the photographing conditions and tag information relating to the photographing mode as stated above, it is possible to output images without applying correction on the condition relating to the photographing mode, if information showing that the photographing mode is manual is recorded, in the case of outputting images with an output means such as a printer. For example, if there is recorded, on the tag information, the information showing that white balance was set to the manual mode as a photographing mode, the output means can output white balance without adjusting white balance.

On the other hand, when photographing was not conducted under the manual mode (step S 11; NO), namely, when photographing was conducted under the automatic photographing mode wherein photographing is conducted under the photographing condition established automatically after detection on the camera side, CPU 2 analyzes an image obtained through photographing (step S 12). To be concrete, CPU 2 analyzes image signals inputted in the image processing section 4, and information about the image is obtained as a result of the analysis. As a result of the analysis, there are given, for example, a color component of each pixel constituting the image, a color component obtained by analyzing luminance, and the state of luminance distribution.

Next, photographing conditions detected and established on the camera side based on the results of the analyses of the image obtained in step S 12 are judged whether they require correction or not (step S 13). This judgment may be made by comparing the results of the analyses thus obtained with a prescribed value.

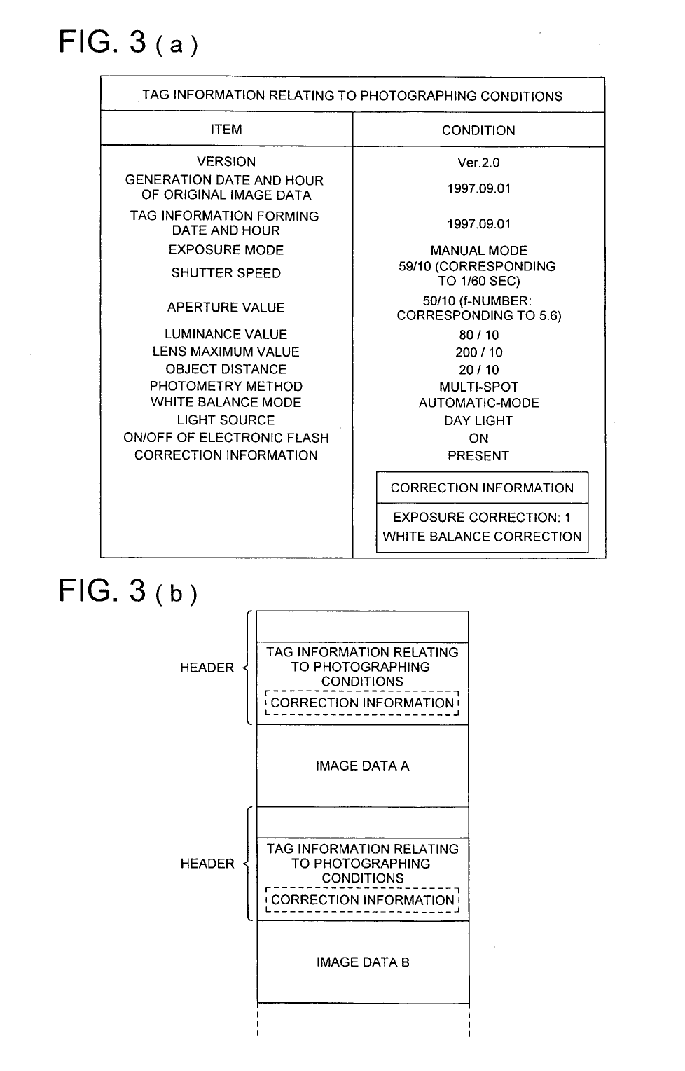

When the results of the analyses are judged to require correction based on the results of the analyses, images are corrected by applying image processing on image data for optimizing the photographing conditions automatically based on the results of the analyses. Further, correction information showing that tag information relating to the photographing mode is corrected is formed (step S 14). Then, there will be formed tag information shown in FIG. 3 including the correction information thus formed. In that case, the tag information relating to the photographing mode is assumed to be the established tag information which has been corrected. Namely, with respect to tag information relating to the photographing mode concerning the photographing conditions judged to require the correction, the established tag information is changed to the corrected tag information. In concrete terms, the photographing mode is recorded not as an automatic photographing mode but as a manual mode (step S 15). Then, the tag information thus formed is added to the corresponding image (step S 17) to terminate the tag information setting process.

Incidentally, when it is recorded on tag information that the photographing mode is a manual mode, it is preferable that correction by an outputting apparatus is not made when outputting the image corresponding to the tag information, with respect to the photographing conditions relating to the photographing mode. Due to this, when photographing is conducted under the manual mode, it is possible to obtain output in which an intention of a user is reflected, and it is possible to obtain more appropriate image even for the image wherein tag information relating to the photographing mode is corrected and set to the manual mode by the image that is corrected so that appropriate photographing conditions may turn out after being photographed under the automatic photographing mode.

For the image optimized (corrected) on the camera side, better results are obtained on the outputting apparatus, if tag information relating to the photographing mode is described as “manual mode” even when the automatic photographing mode was used for photographing, as stated above. In other words, when the photographing conditions are judged not to be optimum and correction is made automatically for image data so that the photographing conditions may become optimal, it is possible to prevent that an image which is against an intention of a user is obtained, by applying further image processing to the image optimized by the camera in the course of image outputting by a printer or the like, by recording “manual mode” for the tag information relating to the photographing mode concerning the photographing conditions optimized.

Next, the embodiment mentioned above will be explained in a more concrete way, referring to FIG. 2 and FIGS. 3(a) and 3(b). Incidentally, there will be explained a camera having, as a photographing mode, two photographing modes concerning exposure conditions and two photographing modes concerning white balance. As a photographing mode concerning exposure conditions, there are provided an automatic exposure photographing mode wherein exposure conditions are set automatically by a camera based on a photometric value and an exposure manual photographing mode wherein exposure conditions are set by a user. As a photographing mode concerning white balance, there are provided an automatic white balance mode wherein white balance is adjusted automatically by a camera based on a colorimetric value and a white balance manual mode wherein white balance conditions (for example, a type of a light source) are set by a user. There will be explained an occasion wherein photographing was carried out after setting each of the automatic exposure photographing mode and the automatic white balance mode.

First, in step S 11, it is judged whether photographing was carried out under the manual mode or not. Since the photographing is carried out after setting to the automatic exposure photographing mode and the automatic white balance mode in the present embodiment, judgment in S 11 is “NO”, and the flow advances to S 12. In S 12, image data obtained through photographing are analyzed. For example, as for the photographing conditions, a luminance value and a dynamic range of the image are calculated as a result of the analysis. Then, in S 13, it is judged whether the photographing conditions need correction or not, based on the results of the analyses obtained in S 12. To be concrete, in the case of an exposure condition, when the luminance value obtained in S 12 is lower than a prescribed value, and the dynamic range is narrower than a prescribed dynamic range, correction to broaden a range of luminance of the image is judged to be necessary, and correction of the exposure conditions is judged to be necessary. An occasion where white balance conditions were judged to require the correction and exposure conditions were judged not to require the correction as a result of the analysis, will be explained as follows, as an example.

When the photographing conditions are judged to require the correction, as a result of the analysis (under the assumption that the photographing conditions need correction, because the exposure conditions are judged to require correction in the present embodiment), image processing is applied to image data in S 14 so that the exposure conditions may become appropriate. In the present embodiment, correction to broaden a range of luminance of the image is applied to image data. Since the exposure conditions require correction, and the correction was applied to the image data so that the exposure conditions may turn out to be appropriate, there is formed correction information including information showing that the exposure conditions were corrected. For example, as shown in FIG. 3(a), “1” is fixed on a flag of the item of the corrected photographing condition. Therefore, in the present embodiment, “1” is fixed on a flag of the item of “exposure correction” because the exposure conditions are corrected, while, a flag of the item of “white balance correction” is made to be “0” because white balance is not corrected.

Next, in S 15, “automatic exposure photographing mode” which sets “exposure model” tag information representing a photographing mode concerning the exposure condition is corrected to “exposure manual photographing mode”. Then, tag information including the correction information and the corrected tag information is formed. It is preferable that this tag information includes at least correction information, tag information concerning a photographing mode and tag information concerning a photographing condition. Incidentally, the tag information concerning a photographing mode and the tag information concerning photographing conditions are corrected and established as stated above, as occasion demands, based on the condition set by a user or a camera in case of photographing.

Then, in S 17, tag information is added to the header representing a forefront area of a recording area for one image portion of image data, as shown in FIG. 3(b).

As a standard of judgment for whether the correction is necessary or not, if a dynamic range expressed by a printer or a display means is made to be a prescribed value, when a dynamic range is lower than the dynamic range expressed by a printer or a display means, it is possible to conduct correction for broadening a range of luminance of the image for printer output and for display by the display means, and a bright image can be obtained automatically.

Incidentally, as an exposure mode, it can be applied even when photographing is conducted with spot AE. Though an exposure mode has been explained as a photographing mode in this case, the same can also be applied for the mode, for example, of white balance.

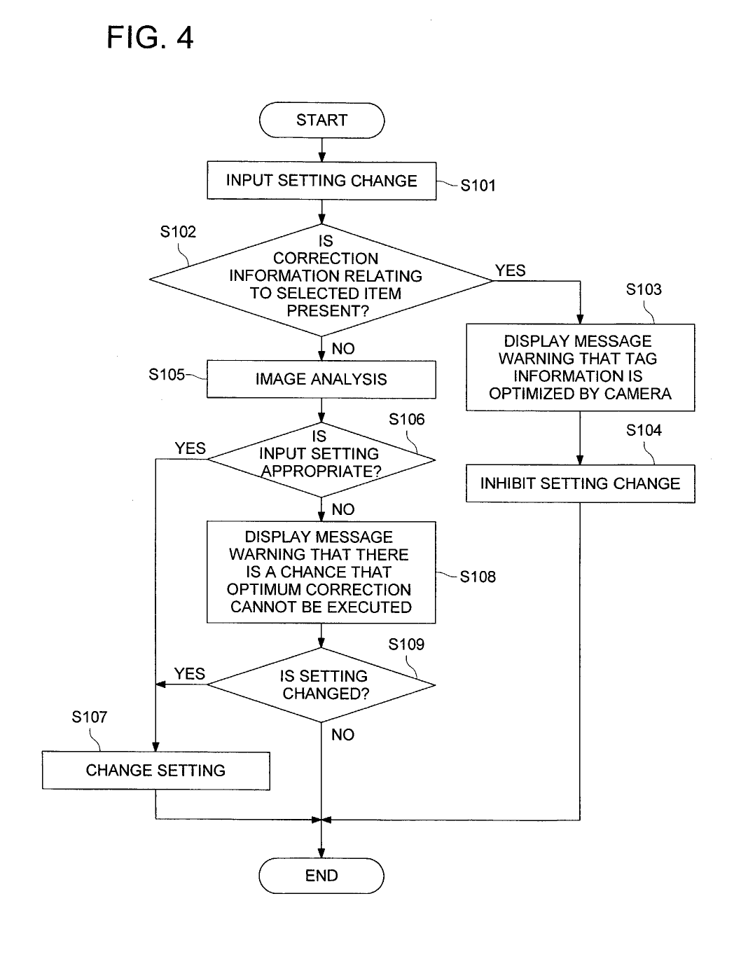

Next, there will be explained tag information change processing which is conducted when the setting of tag information is changed by a user by referring to FIG. 4.

FIG. 4 is a flow chart that illustrates tag information change processing that is conducted by CPU 2 in FIG. 1.

In FIG. 4, CPU 2 first displays a setting change screen for changing the setting of tag information on display section 5, and makes a user to input a type of tag to be changed and contents of the change through operation section 6 (instruction means) (step S 101). Then, CPU 2 judges whether or not the correction information has contents of correction relating to tag which is inputted by a user at step S 101 by referring to tag information for which the user intends to change the setting, namely the tag information corresponding to the instruction for change inputted through operation section 6 (step S 102). When the correction information has the contents of the correction relating to tag information whose setting is to be changed (step S 102; YES), the change of the setting is judged not to be necessary, because an image is analyzed on the camera side after photographing and the setting is automatically optimized and corrected, thus, a warning message such as “established tag information has been optimized by the camera” is displayed on display section 5 (step S 103), and the change of setting of tag information is prohibited (step S 104).

For example, when a user intends to change a exposure mode representing a tag concerning a photographing mode from “exposure manual photographing mode” to “automatic exposure photographing mode”, if flag 1 is fixed at “exposure correction” of the correction information, the change of the setting is judged not to be necessary. However, when a user intends to change “exposure mode”, if flag 1 is not fixed at “exposure correction” of correction information to be 0 and if flag 1 is fixed at white balance correction only, the correction information is judged to have no contents of correction relating to tag information whose setting is to be changed.

On the other hand, when the correction information does not have contents of correction relating to tag information which is to be changed in terms of setting (step S 102; NO), images obtained through photographing are analyzed (step S 105), and the setting (condition) inputted by a user is judged whether it is appropriate or not based on the results of the analyses (step S 106). When the inputted setting is judged to be appropriate (step S 106; YES), the inputted setting is recorded on the tag information to change the setting (step S 107), and the tag information change processing is terminated. On the other hand, when the inputted setting is judged not to be appropriate (step S 106; NO), a warning message which warns that “there is a possibility to be unable to conduct optimum correction on the output apparatus side in the course of outputting, under the inputted setting”, for example, a warning message such as “this setting has a possibility to be unable to conduct optimum correction” is displayed on display section 5 (step S 108). Then, CPU 2 makes display section 5 to display a message for inquiring whether to change tag information with the inputted setting independently of the message or not, and judges whether the instruction to change the setting has been received from a user or not (step S 109).

When the instruction to change the setting is not received from a user (step S 109; NO), tag information that is set without changing the setting is added to the image (step S 110) and tag information change processing is terminated. On the other hand, when the instruction to change the setting is received from a user (step S 109; YES), the setting inputted at step S 101 is recorded on tag information to change the setting (step S 107) and tag information change processing is terminated.

As stated above, images obtained through photographing are analyzed, and based on the results of the analyses, the photographing conditions are judged whether they need correction or not, and when the correction is needed, image processing is applied to image data so that photographing conditions may be optimized automatically from the results of analyses of the image, then, tag information relating to a photographing mode concerning the photographing conditions is corrected, and tag information on which correction information showing that correction has been made is recorded is formed. When the correction is not needed, tag information including photographing conditions in the course of photographing is formed, and is added to the corresponding image, thereby, photographing conditions optimum for outputting of photographed images, or photographing conditions desired by a user can be set as tag information. Accordingly, a user can output an image which has high image quality and gives a feeling of high satisfaction, by referring to the tag information in the course of outputting.

Further, when the established tag information is changed by a user, the tag information is judged whether it has correction information or not, and when the tag information has the correction information, a warning message which warns that the tag information has been optimized on the camera side is displayed, and a change of the setting is prohibited. When the tag information has no correction information, images obtained through photographing are analyzed, and based on the results of the analyses, the setting inputted by a user through the change is judged whether it is appropriate or not, and when the setting is not appropriate, a warning message which warns a possibility that optimum correction may not be carried out is displayed, and the setting is changed and tag information is added to the image, when there is an instruction for changing independently of the warning, thereby, the wrong setting by the user can be prevented, and setting conditions optimum for outputting of images, or the setting conditions desired by a user can be set as tag information. Accordingly, a user can output an image which has high image quality and gives a feeling of high satisfaction, by referring to the tag information in the course of outputting.

Incidentally, contents of the description in the present embodiment represent an ideal example of an image pick-up device relating to the invention to which, however, the invention is not limited.

For example, though there has been explained an occasion where tag information about photographing conditions is added to the image, in the present embodiment, the invention is not limited to this, and it can be applied to tag information concerning the information obtained by analyzing images, such as subject information of images and information of the weather.

Further, a warning message that warns about an inappropriate setting may be either a message which just warns that the setting is not appropriate for each occasion, or a message which suggests the optimum setting.

For example, in the case of recording information such as a “landscape” and a “night scene” as subject information on tag information of the image on which a person is photographed in the night scene, when a user sets “landscape” by mistake, it is possible to analyze the state of distribution of luminance components of the image obtained through photographing, then, to judge that the subject information of the image is “night scene” because a prescribed range of the total area of the image is occupied by pixels each having a low value of luminance component, and to display a warning message that suggests an optimum setting represented by “optimum setting is a night scene”.

In addition to the foregoing, even for the detailed structures of each constituent section that constitutes digital camera 1 and for detailed operations, it is possible to modify them properly without deviating from the spirit of the invention.

The invention makes it possible to provide a highly convenient electronic instrument wherein tag information that is optimum for an image can be established.

In particular, in the Structures (1)-(4) and (13), tag information is judged whether it is appropriate or not based on the results of analyses of the image, and when it is judged not to be appropriate, correction information showing that tag information was corrected is formed to be included in the tag information. It is therefore possible to add tag information that is optimum for output of the image to the image, and thereby to improve convenience.

Therefore, a user can output an image which has high image quality and gives feeling of high satisfaction, by referring to this tag information in the course of outputting.

Further, in the Structure (4), when the tag information concerning radiographing conditions is judged not to be appropriate, the image is subjected to image processing. Therefore, it is possible to obtain easily an image that matches the tag information more and has high image quality.

In the Structures (5)-(12), when there is given an instruction for changing the setting of tag information, the instruction for changing the setting is judged whether it is appropriate or not, and when the instruction for changing the setting is judged to be appropriate, the tag information is changed to the instructed setting, which makes it possible for a user to set desired tag information properly. Accordingly, a user can output an image having high image quality and giving a feeling of high satisfaction, by referring to the tag information in the course of outputting.

Further, in the Structure (7), correction information showing that the tag information was corrected is formed based on the results of the analyses of the image obtained through radiographing, and tag information is set by adding the formed correction information to the set tag information, and the instructions for changing the settings of tag information is judged whether it is appropriate or not by judging whether the tag information instructed by the instruction means includes the correction information or not. Therefore, the tag information desired by a user can be established to be more suitable for the image.

In the Structure (8) or (9), it is possible to prevent wrong setting.

In the Structure (10), tag information instructed to be changed in terms of setting based on the results of analyses of the image is judged whether it is appropriate or not, which makes it possible to set the tag information that is optimum for outputting images.

In the Structure (11), tag information is changed in accordance with the instruction for changing the setting, independently of the result of the judgment. Therefore, setting desired by a user, for example, setting reflecting the user's taste can be conducted.

The Structure (12) makes it possible to obtain an image which is desired more by a user, in the case of output.

What is claimed is:

1. An electronic instrument comprising:
(a) an analyzer for analyzing an image stored in an image storage device;
(b) a judging device for judging whether tag information corresponding to the image is appropriate or not, based on an analyzed result of the tag information being stored in the storage device;
(c) a correction information forming device for forming correction information showing that the tag information has been corrected based on the analyzed result, when the tag information related with the image is judged not to be appropriate; and
(d) a tag information setting device for setting the tag information that includes the correction information.

2. The electronic instrument of claim 1, further comprising:
an imaging device for picking up the image; an image storage device for storing the image picked up by the imaging device wherein the tag information setting device sets the tag information corresponding to the image picked up by the imaging device, and
a storage controller for making the image storage device to store the tag information related with the image picked up by the imaging device.

3. The electronic instrument of claim 2, further comprising a correcting device for correcting a second tag information relating to a photographing mode,
wherein the tag information setting device sets a first tag information relating to a photographing condition and the second tag information, the judging device judges whether the first tag information relating to the photographing condition is appropriate or not, the correcting device corrects the second tag information when the first tag information that has been set is judged not to be appropriate by the judging device, and the correction information forming device forms correction information showing that the second tag information was corrected when the first tag information that has been set is judged not to be appropriate.

4. The electronic instrument of claim 2, further comprising an image processor for conducting image processing for the image when the set tag information relating to a photographing condition is judged not to be appropriated by the judging device.

5. An electronic instrument comprising:
(a) an instructing device for instructing to change a setting of tag information related with an image stored in an image storage device;
(b) a judging device for judging whether an instruction for changing the setting of the tag information by the instructing device is appropriate or not; and
(c) a tag information setting device for changing the tag information to the setting instructed by the instructing device, when the instruction for changing the setting of the tag information is judged to be appropriate by the judging device.

6. The electronic instrument of claim 5, further comprising:
an imaging device for picking up the image; an image storage device for storing the image picked up;
a tag information setting device for setting the tag information relating with the image picked up; and
a storage controller for making the image storage device to store the set tag information related with the image picked up.

7. The electronic instrument of claim 6, further comprising:
an analyzer for analyzing the image picked up; and
a correction information forming device for forming correction information showing that the tag information has been corrected based on an analyzed result by the analyzer,
wherein the tag information setting device sets the tag information by adding the correction information to the set tag information, while the judging device judges whether the instruction to change the setting of tag information carried out by the instruction device is appropriate or not by judging whether the tag information instructed by the instruction device includes the correction information or not.

8. The electronic instrument of claim 6, further comprising a warning device for warning that the tag information is optimized and a change of the setting is not appropriate accordingly, when the instruction to change the setting of tag information is judged not to be appropriate by the judging device.

9. The electronic instrument of claim 6, wherein when the instruction to change the setting of tag information is judged not to be appropriate by the judging device, the tag information setting device prohibits the change of tag information that conforms to the instruction to change the setting of tag information given by the instruction device.

10. The electronic instrument of claim 6, wherein the judging device judges whether the tag information instructed by the instruction device is appropriate or not, based on the analysis result made by the analyzer.

11. The electronic instrument of claim 6, wherein the tag information setting device changes the tag information instructed by the instruction device, independently of a judgment result by the judging device.

12. The electronic instrument of claim 6, wherein the tag information setting device sets a first tag information relating to a photographing condition and a second tag information relating to a photographing mode, and the instruction device gives an instruction to change the setting of the second tag information.

13. An electronic instrument comprising:
(a) an imaging device for picking up an image;
(b) an image storage device for storing the image picked up;
(c) a tag information setting device for setting tag information relating with the image picked up;
(d) a storage controller for making the image storage device to store the set tag information related with the image picked up;
(e) an analyzer for analyzing the image picked up;
(f) a judging device for judging whether the tag information set by the tag information setting device is appropriate or not, based on an analyzed result by the analyzer; and
(g) a correction information forming device for forming correction information showing that the tag information has been corrected based on the analyzed result, when the tag information set was judged not to be appropriate,
wherein the tag information setting device sets the tag information including the formed correction information.
